(19) United States
(12) Patent Application Publication
(10) Pub. No.: US 2004/0000873 A1
(43) Pub. Date: Jan. 1, 2004

(54) Plasma display panel including barrier ribs and method for manufacturing barrier ribs

(76) Inventor: Cheol-Hee Moon, Cheonan-city (KR)

Correspondence Address: McGuireWoods, Suite 1800, 1750 Tysons Boulevard, McLean, VA, 22102-4215, US

(21) Appl. No.: 10/607,152

(22) Filed: Jun. 27, 2003

(30) Foreign Application Priority Data
Jun. 28, 2002 (KR) 2002-36932

(51) Int. Cl. H01J 17/49

(52) U.S. Cl. 313/587; 313/582; 313/586

(57) ABSTRACT

The present invention provides a plasma display panel and a method for manufacturing barrier ribs for the plasma display panel. The plasma display panel includes first and second substrates that have a predetermined gap therebetween. A plurality of parallel address electrodes are formed on the first substrate. A dielectric layer is formed on the first substrate covering the address electrodes and barrier ribs are formed on the dielectric layer in a lattice pattern. Discharge sustain electrodes are formed on the second substrate which is perpendicular to the address electrodes, and a transparent dielectric layer and a protection layer are formed on the second substrate covering the discharge sustain electrodes. The barrier ribs are, for example, first and second barrier rib members which are formed respectively in the same direction as the address electrodes and the discharge sustain electrodes. Either or both the first barrier rib members or the second barrier rib members are made of a non-transparent material.

### CROSS REFERENCE TO RELATED APPLICATION

This application is based on Korean Patent Application No. 2002-0036932 filed on Jun. 28, 2002. The content of the Application is fully incorporated by reference herein.

### BACKGROUND OF THE INVENTION

1. Field of the Invention

The present invention relates to a method for manufacturing the barrier ribs and to a plasma display panel, and more particularly, to a plasma display panel in which substantially all of the red, green, and blue pixels are substantially surrounded by at least a portion of a plurality of barrier ribs.

2. Description of the Related Art

A plasma display panel (PDP) is typically a display in which ultraviolet rays, which are generated by the discharge of gas, excite phosphors to realize predetermined images. As a result of the high resolution possible with PDPs, it is possible that PDPs will become one of the major next generation flat panel display configurations.

In known PDPs, such as, the PDP shown in FIG. 13, address electrodes 3 are formed along a Y-axis direction on a rear substrate 1, and a dielectric layer 5 is formed over a surface of the rear substrate 1 covering the address electrodes 3. Also, barrier ribs 7 are formed in a line pattern on the dielectric layer 5 and at locations corresponding to locations between the address electrodes 3. Formed between the barrier ribs 7 are red, green, and blue phosphor layers 9.

Discharge sustain electrodes 17, which are each realized through a pair of transparent electrodes 13 and a pair of bus electrodes 15 are formed on a front substrate 11 which opposes the rear substrate 1. That is, the pair of transparent electrodes 13 and the pair of bus electrodes 15, which make up each of the discharge sustain electrodes 17, are formed along an X-axis direction on the front substrate 11. A transparent dielectric layer 19 and an MgO protection layer 21 are formed over a surface of the front substrate 11 covering the discharge sustain electrodes 17. Pixels of a screen are formed where the address electrodes 3 and the discharge sustain electrodes 17 intersect.

A PDP configured in this manner operates as follows. Following the application of an address voltage Va between the address electrodes 3 and one of the discharge sustain electrodes 17 which corresponds to a particular pixel to perform address discharge, a sustain voltage Vs is applied between two of the discharge sustain electrodes 17 corresponding to this pixel. As a result, ultraviolet light generated during sustain discharge excites the phosphor layer 9 of the corresponding pixel to emit visible light.

However, in the PDP structure including the barrier ribs 7 in a line pattern, since discharge cells of the pixels are interconnected in the direction that the barrier ribs 7 are arranged (i.e., along the Y-axis direction for the PDP shown in FIG. 13), it is possible for mis-discharge to take place between the pixels. One way to prevent mis-discharge is to increase a distance between the discharge sustain electrodes 17 of adjacent pixels to at least a predetermined length. A drawback of such a structure, however, is that a low aperture ratio of the PDP results.

Another way to prevent the mis-discharge between adjacent pixels is to provide a plurality of vertical barrier ribs that serve as vertical walls which completely surround all of the R, G, and B pixels such that fully separated discharge cells are formed. That is, vertical barrier ribs are formed between the pixels by having some vertical barrier ribs situated along a direction parallel to the address electrodes and some vertical barrier ribs situated along a direction parallel to the discharge sustain electrodes. This results in each of the pixels being completely surrounded in the vertical direction by a combination of the barrier ribs situated along the two directions. Japanese Laid-open Patent No. 1998-149771 discloses such a configuration.

There is also disclosed a PDP structure in which, in addition to R, G, and B pixels being surrounded by the vertical barrier ribs, a set of R, G, and B pixels are arranged in a triangular configuration, which is referred to as a delta configuration. U.S. Pat. No. 5,182,489 discloses such a PDP.

However, the barrier ribs for separating the discharge cells of the pixels have been designed without giving much thought to how picture contrast is affected. Further, in the conventional structure, since all the R, G, and B pixels are completely surrounded by the vertical barrier ribs, exhaust does not take place in an efficient manner during manufacture. This reduces the overall quality of the panel.

### SUMMARY OF THE INVENTION

This invention provides a plasma display panel that uses barrier ribs to improve screen contrast, provides for excellent exhaust efficiency with respect to red, green, and blue pixels, is simple to manufacture, and is low in cost. The methods of this invention separately provide a method for manufacturing the barrier ribs.

In one exemplary embodiment of this invention, the plasma display panel includes a first substrate and a second substrate that are substantially parallel and have a predetermined gap therebetween, a plurality of address electrodes formed on a surface of the first substrate opposing the second substrate, where the address electrodes are provided in a line pattern and are substantially parallel, a dielectric layer formed over a surface of the first substrate covering the address electrodes, barrier ribs formed on the dielectric layer in a lattice pattern, the barrier ribs defining discharge cells, a plurality of discharge sustain electrodes formed on a surface of the second substrate which is opposing the first substrate, the discharge sustain electrodes being formed in a line pattern and in a direction that is substantially perpendicular to the address electrodes, and a transparent dielectric layer and a protection layer formed over the surface of the second substrate which is covering the discharge sustain electrodes. The barrier ribs include first barrier rib members formed along the same direction as the address electrodes, and second barrier rib members formed along the same direction as the discharge sustain electrodes, where either or both the first barrier rib members or the second barrier rib members being made of a non-transparent material.

In various embodiments of this invention, the non-transparent material is, for example, a black pigment selected from the group consisting of chrome oxide, copper oxide, PbO, and Al₂O₃.

In various embodiments of this invention, the first barrier rib members and the second barrier rib members are formed at different heights such that the discharge cells of pixels may communicate between spaces formed at upper ends of the shorter barrier rib members.

This invention separately provides a method for manufacturing barrier ribs for a plasma display panel includes preparing a first substrate having formed thereon address electrodes and a dielectric layer, and printing a first insulating paste over a surface of the dielectric layer and forming a lower barrier rib member of a first predetermined height, printing a second insulating paste on the lower barrier rib member in a line pattern and forming upper barrier rib members having a second predetermined height from a surface of the dielectric layer, coating a dry film resistor over a surface of the first substrate covering the lower barrier rib member and the upper barrier rib members, positioning a photo mask, which has a lattice-shaped light passage pattern, over a surface, of the dry film resist, then performing exposure through the light passage pattern to pattern the dry film resist such that the dry film resist covers all of the upper barrier rib members and part of the lower barrier rib member, and spraying sand at a high speed onto the surface, of the first substrate such that exposed portions of the lower barrier rib member are removed, after which the dry film resist remaining on the first substrate is removed.

In various embodiments of this invention, either or both the first and second insulating layer pastes are made of non-transparent material.

### BRIEF DESCRIPTION OF THE DRAWINGS

These and other features and advantages of this invention are described in the following detailed description of various exemplary embodiments of the systems and methods according to this invention.

The accompanying drawings, which are incorporated in and constitute a part of the specification, illustrate various exemplary embodiments of the invention, and, together with the description, serve to explain the principles of the invention:

FIG. 1 is a partial exploded perspective view of a plasma display panel according to a first exemplary embodiment of the present invention;

FIG. 2 is a sectional view showing the plasma display panel of FIG. 1 in an assembled state and cut along an X-axis direction;

FIGS. 3, 4 and 5 are schematic views showing different configurations of barrier ribs according to various exemplary embodiments of the present invention;

FIG. 6 is a partial enlarged perspective view of a rear substrate of the plasma display panel of FIG. 1;

FIG. 7 is a partial exploded perspective view of a plasma display panel according to a second exemplary embodiment of the present invention;

FIGS. 8, 9, 10, 11 and 12 are schematic views showing sequential steps for manufacturing barrier ribs for the plasma display panel of FIG. 1; and

FIG. 13 is a partial exploded perspective view of a conventional plasma display panel.

### DETAILED DESCRIPTION OF THE EXEMPLARY EMBODIMENTS

Exemplary embodiments of the present invention will now be described in detail with reference to the accompanying drawings.

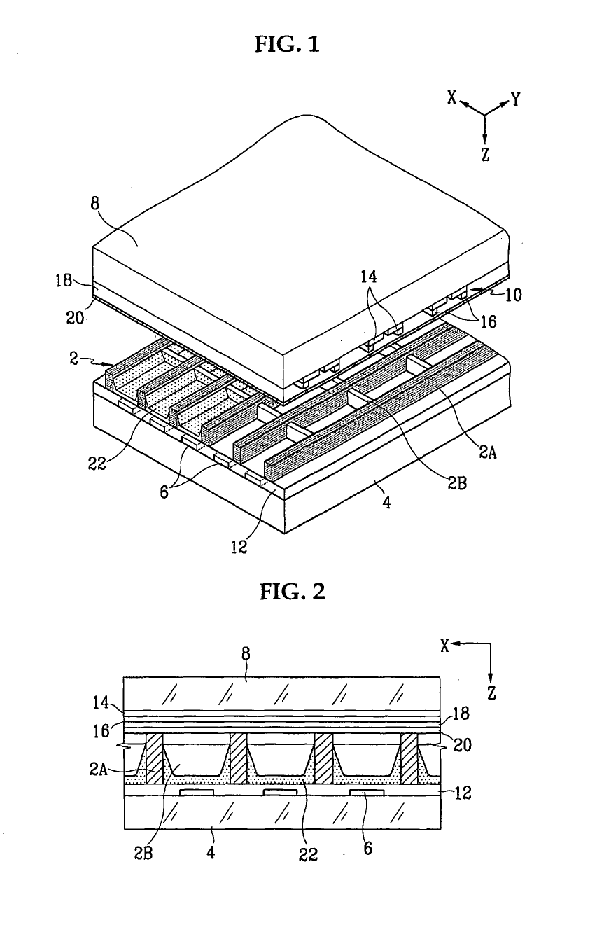

FIG. 1 is a partial exploded perspective view of a plasma display panel (PDP) according to a first exemplary embodiment of the present invention, and FIG. 2 is a sectional view showing the PDP of FIG. 1 in an assembled state and cut along an X-axis direction.

As shown in the drawings, corresponding portions of the barrier ribs 2 surround, in a “wall-like” manner, a plurality of R, G, and B pixels in a quadrilateral shape, for example, to define discharge cells. Corresponding to each of the pixels, address electrodes 6 are provided on a rear substrate 4 and discharge sustain electrodes 10 are provided on a front substrate 8. With this structure, illumination of the pixels and the intensity of illumination may be independently controlled.

In more detail, a plurality of the address electrodes 6 are formed in a line pattern in Y-axis direction on the rear substrate 4. A dielectric layer 12 is formed over a surface of the rear substrate 4 covering the address electrodes 6. The barrier ribs 2, which include first barrier rib members 2A and second barrier rib members 2B, are formed at a predetermined height on the dielectric layer 12.

The discharge sustain electrodes 10 are formed in a line pattern along an X-axis direction on the front substrate 8. The discharge sustain electrodes 10 are each realized through a pair of transparent electrodes 14 and a pair of bus electrodes 16. Regions where the address electrodes 6 of the rear substrate 4 and the discharge sustain electrodes 10 of the front substrate 8 intersect to form pixels. Further, a transparent dielectric layer 18 and an MgO protection layer 20 are formed over a surface of the front substrate 8 covering the discharge sustain electrodes 10.

The first barrier rib members 2A are formed on the dielectric layer 12 of the rear substrate 4 at locations between the address electrodes 6 and substantially parallel to the same. The second barrier rib members 2B are provided on the dielectric layer 12 of the rear substrate 4 at locations between each of the discharge sustain electrodes 10 and substantially parallel to the same. In addition, R, G, and B phosphor layers 22 are positioned in the pixel regions, which are surrounded by the first and second barrier rib members 2A and 2B.

Following the application of an address voltage Va between the address electrodes 6 and one of the discharge sustain electrodes 10 corresponding to a particular pixel to perform address discharge, a sustain voltage Vs is applied between two of the discharge sustain electrodes 10 corresponding to this pixel. As a result, vacuum ultraviolet light generated during sustain discharge excites the phosphor layers 22 of the corresponding pixel to emit visible light.

In the first exemplary embodiment of the present invention, the first barrier rib members 2A or the second barrier rib members 2B (or both) are made non-transparent, that is, as black members, to improve picture contrast. Also, the first barrier rib members 2A and the second barrier rib members 2B are formed to different heights such that discharge cells of the pixels are in communication via the barrier rib members of the lower height. This allows for an increase in exhaust efficiency during manufacture of the PDP.

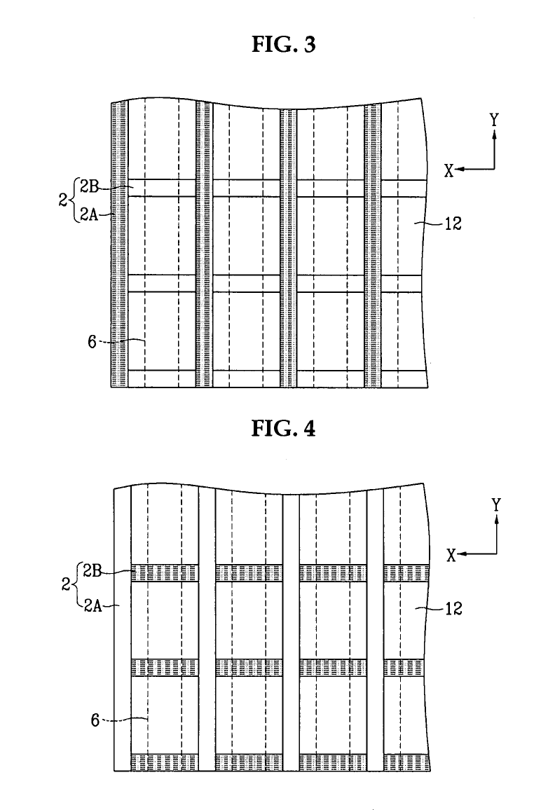

With reference to FIG. 3, the barrier ribs 2 according to one exemplary embodiment of the present invention are structured such that the first barrier rib members 2A are non-transparent to improve contrast between the pixels positioned along the X-axis direction. As shown in FIG. 4, the barrier ribs according to another exemplary embodiment of the present invention are structured with the second barrier rib members 2B being non-transparent to improve contrast between the pixels positioned along the Y-axis direction.

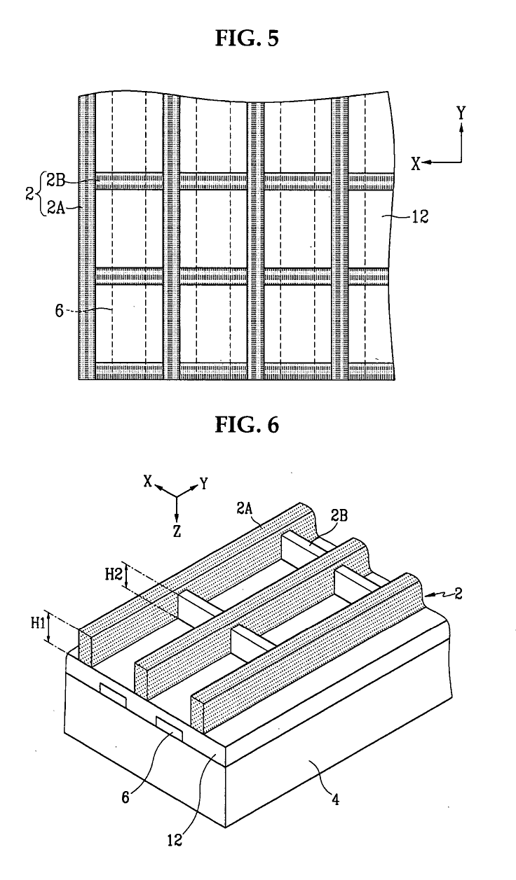

Further, with reference to FIG. 5, in yet another exemplary embodiment of the present invention, the first barrier rib members 2A and the second barrier rib members 2B are both nontransparent so that the contrast between all pixels is improved.

The first barrier rib members 2A of FIG. 3, the second barrier rib members 2B of FIG. 4, and the first and second barrier rib members 2A and 2B of FIG. 5 are made black with black pigments which are realized through a metal oxide, such as, for example, chrome oxide, copper oxide, PbO, or Al₂O₃ coated on the dielectric layer 12 together with a glass paste to form the barrier ribs 2.

FIG. 6 is a partial enlarged perspective view of the rear substrate 4. The first barrier rib members 2A and the second barrier rib members 2B are formed to different heights as described above. As an example, if the first barrier rib members 2A are formed to a height of H1, the second barrier rib members 2B are formed to a height of H2, which is less than the height H1. Accordingly, if the front and rear substrates 8 and 4 are assembled together, spaces are formed above the second barrier rib members 2B. The spaces above the second barrier rib members 2B communicate with pixels that are adjacent in the Y-axis direction so that exhaust of the pixels may be performed smoothly.

It is also possible for the first barrier rib members 2A to be formed at a lesser height than the second barrier rib members 2B to result in spaces being formed above the first barrier rib members 2A. If H2 is greater than H1, the spaces above the first barrier rib members 2A communicate with pixels that are adjacent in the X-axis direction.

Therefore, in the PDP according to the first exemplary embodiment of the present invention, the barrier ribs 2 surround each of the pixels in “wall-like” manner and in a quadrilateral shape to prevent mis-discharge between the pixels, at least one of the first and second lattice wall members 2A and 2B are made black to improve picture contrast, and the first and second lattice wall members 2A and 2B are formed with different heights to allow for the good exhaust of the PDP.

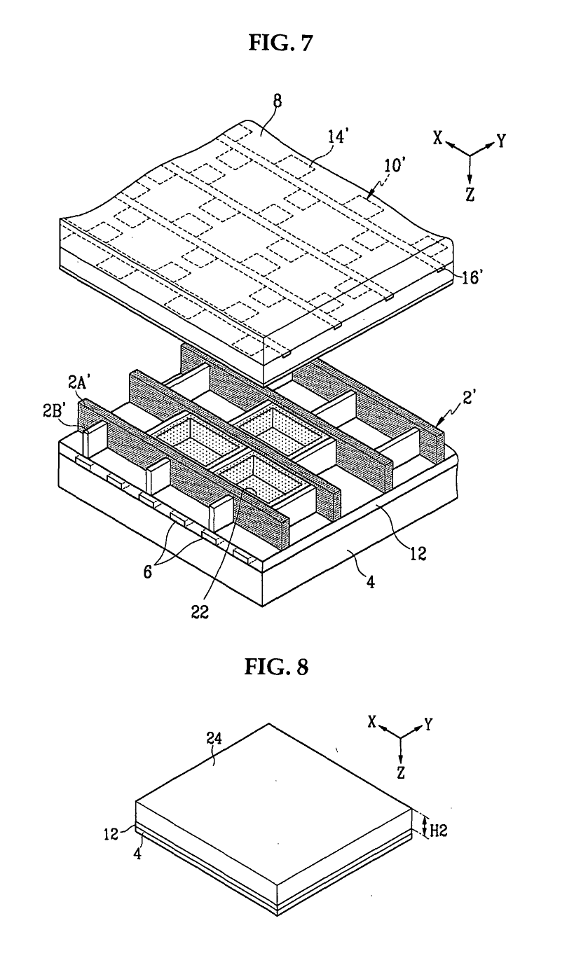

FIG. 7 is a partial exploded perspective view of a plasma display panel according to a second embodiment of the present invention. The same reference numerals will be used for elements identical in structure to those described with reference to the first embodiment of the present invention.

Barrier ribs 2′ include a plurality of first barrier rib members 2A′ formed in a stripe pattern perpendicular to a direction as the address electrodes 6 (i.e., the X-axis direction) on the dielectric layer 12 of the rear substrate 4, and a plurality of second barrier rib members 2B′ formed within a space between two neighboring first barrier rib members 2A′ on the dielectric layer 12. The barrier rib members 2A′, 2B′ define the discharge cells which are arranged in zigzag manner along a same direction as the address electrodes 6 (i.e., the Y-axis direction). In this embodiment, the second barrier rib members 2B′ are formed in the same direction as the address electrodes 6. By having discharge cells arranged in a zigzag manner, the area of light emission and the applied area of the phosphor increase. As a result, the efficiency of light emission and the brightness of the display panel may be improved.

To establish the zigzag arrangement of the discharge cells, the second barrier rib members 2B′ are formed over every other address electrode 6 and the second barrier rib members 2B′ forming the discharge cells in the space defined by two adjacent first barrier rib members 2A′ are not aligned with the second barrier rib members 2B′ forming the discharge cells in the adjacent spaces defined by first barrier rib members 2A′. Thus, as shown in FIG. 7, the second barrier rib members 2B′ are shifted such that the second barrier rib members 2B′ are situated on different address electrodes in the spaces formed by adjacent pairs of first barrier rib members 2A′. Accordingly, each set of R, G, and B pixels is arranged in substantially a triangular (i.e., delta) shape.

For example, to establish the zigzag arrangement of the discharge cells, a first set of the barrier rib members 2B′ may be formed on a first set of every other address electrodes and a second set of the barrier rib members 2B′ may be formed on a second set address electrodes which includes at least some of the address electrodes on which the barrier rib members of the first set are not arranged.

In the second exemplary embodiment of the present invention, either or both the first barrier rib members 2A′ and the second barrier rib members 2B′ may be non-transparent to improve picture contrast. Also, a height of the first barrier rib members 2A′ is greater than a height of the second barrier rib members 2B′ so that spaces are formed over the second barrier rib members 2B′ after the front and rear substrates 8 and 4 are assembled together.

With this formation of the second barrier rib members 2B′, discharge cells adjacent in the X-axis direction are in communication such that good exhaust of the PDP may take place. It is also possible for the height of the first barrier rib members 2A′ to be less than the height of the second barrier rib members 2B′ such that spaces are formed over the first barrier rib members 2A′.

Further, in the case where the barrier ribs 2′ are arranged so that each set of R, G, and B pixels is triangular in shape, it is preferable that discharge sustain electrodes 10′ which are formed on the front substrate 8 are realized through bus electrodes 16′ formed in a line pattern corresponding to the locations of the first barrier rib members 2A′, and transparent electrodes 14′ integrally extended from both sides of the bus electrodes 16′ so that they are positioned within areas corresponding to each pixel when the substrates 4 and 8 are assembled.

Manufacture of the barrier ribs 2 of the first exemplary embodiment of the present invention will now be described with reference to FIGS. 8 through 12. An example of a manufacturing method will be described where the first barrier rib members 2A are nontransparent (see FIG. 3), and the first barrier rib members 2A are greater in height than the second barrier rib members 2B (see FIG. 2).

First, with reference to FIG. 8, the rear substrate 4 with the dielectric layer 12 and address electrodes (not shown) formed thereon is prepared, then after a white insulating paste is printed over the surface of the dielectric layer 12, sintering is performed to form a lower barrier rib member 24 to a height H2.

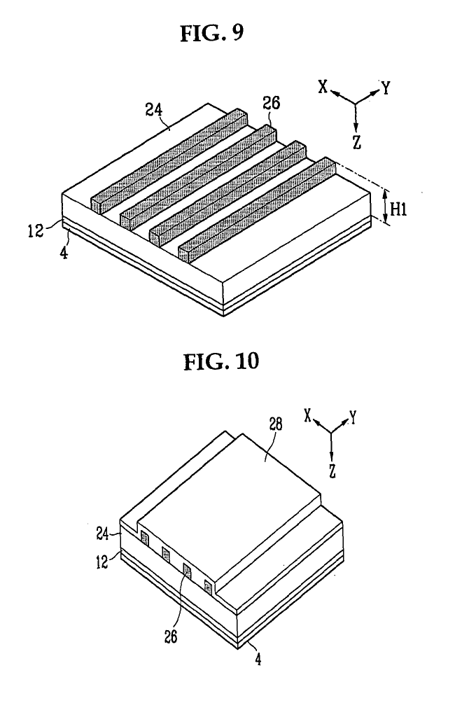

Next, with reference to FIG. 9, black insulating paste is printed in a line pattern between the address electrodes and on the lower barrier rib member 24, after which sintering is performed so that upper barrier rib members 26 are formed. The upper barrier rib members 26 have a height H1 from an upper surface of the dielectric layer 12.

The white insulating paste is made, for example, of typical barrier rib material that does not contain any black pigments (i.e., glass paste), and the black insulating paste is made of a mixture of glass paste and black pigment, in which chrome oxide, copper oxide, PbO, or Al₂O₃ may be used as the black pigment.

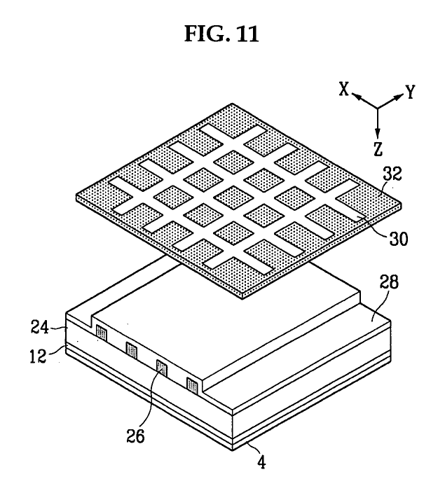

Next, with reference to FIG. 10, a dry film resist (DFR) 28 is coated on the surface of the dielectric layer 12, covering the upper barrier rib members 26 and the lower barrier rib member 24. With reference to FIG. 11, a photo mask 32 having a lattice shaped light passage pattern 30 is placed over uppermost elements formed on the rear substrate 4, after which exposure is performed.

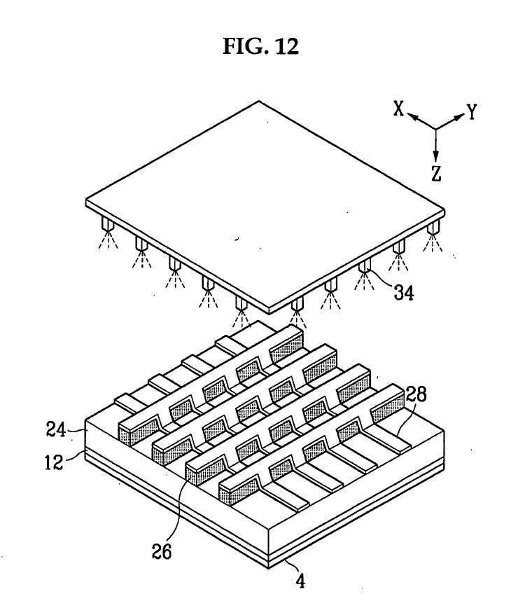

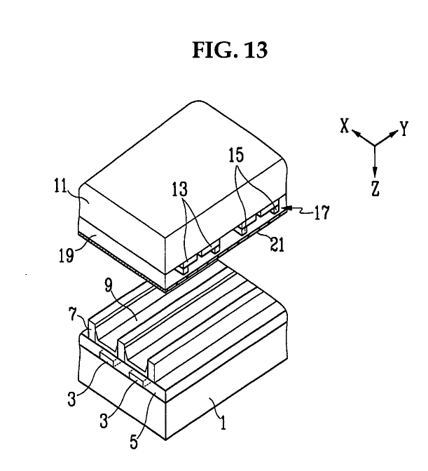

Accordingly, as shown in FIG. 12, the dry film resist 28 is left remaining on the upper barrier rib members 26 and on the lower barrier rib member 24 in the form of the light passage pattern 30. That is, the dry film resist 28 is formed directly on an upper surface of the upper barrier rib members 26 and in a striped pattern intersecting these portions formed on the upper barrier rib members 26.

Subsequently, the rear substrate 4 is mounted to a sandblaster (not shown), then sand is sprayed through nozzles 34 at a high speed onto the uppermost elements of the rear substrate 4. Part of the lower barrier rib member 24 is removed through this process. At this time, the dry film resist 28 acts to protect all of the upper barrier rib members 26 and part of the lower barrier rib member 24 that will subsequently become second barrier rib members from the sprayed sand.

Finally, the dry film resist 28 remaining on the rear substrate 4 is removed. With reference to FIG. 6, resulting from these processes are the black first barrier rib members 2A formed along the Y-axis direction on the dielectric layer 12 and at the height of H1, and the white second barrier rib members 2B formed along the X-axis direction on the dielectric layer 12 and at the height of H2.

Therefore, the method of manufacturing the barrier ribs 2 according to the exemplary embodiments of the present invention, overall costs are reduced since high priced photosensitive material is not used for the barrier rib material. Also, because only one printing and exposure process of the dry film resist 28 is performed, and the upper and lower barrier rib members 24 and 26 are easily patterned by the single sandblasting process, manufacture is made easy.

Although exemplary embodiments of the present invention have been described in detail herein, it should be clearly understood that many variations and/or modifications of the basic inventive concepts herein taught which may appear to those skilled in the present art will still fall within the spirit and scope of the present invention, as defined in the claims.

What is claimed is:

1. A plasma display panel, comprising:
a first substrate and a second substrate that are substantially parallel and have a predetermined gap therebetween;
a plurality of address electrodes formed on a surface of the first substrate opposing the second substrate, the address electrodes being provided in a line pattern and being substantially parallel with each other;
a dielectric layer formed over a surface of the first substrate covering the address electrodes;
barrier ribs formed on the dielectric layer in a lattice pattern, the barrier ribs defining discharge cells;
a plurality of discharge sustain electrodes formed on a surface of the second substrate which opposes the first substrate, the discharge sustain electrodes being formed in a line pattern in a direction substantially perpendicular to the address electrodes; and
a transparent dielectric layer and a protection layer formed over the surface of the second substrate covering the discharge sustain electrodes,
wherein the barrier ribs include first barrier rib members formed along a same direction as the address electrodes, and second barrier rib members formed along a same direction as the discharge sustain electrodes, and wherein at least one of the first barrier rib members and the second barrier rib members is made of a non-transparent material.

2. The plasma display panel of claim 1, wherein the non-transparent material is a black pigment selected from the group consisting of chrome oxide, copper oxide, PbO, and Al₂O₃.

3. The plasma display panel of claim 1, wherein the first barrier rib members and the second barrier rib members have different heights.

4. The plasma display panel of claim 3, wherein a height of the first barrier rib members is greater than a height of the second barrier rib members, such that at least adjacent discharge cells may communicate via a space at an end of the second barrier rib members.

5. The plasma display panel of claim 3, wherein a height of the first barrier rib members is less than a height of the second barrier rib members, such that at least adjacent discharge cells may communicate via a space at an end of the first barrier rib members.

6. The plasma display panel of claim 3, wherein the first barrier rib members are arranged substantially in parallel with and at locations between the address electrodes, and the second barrier rib members are arranged substantially in parallel with and at locations between the discharge sustain electrodes.

7. The plasma display panel of claim 1, wherein the first barrier rib members and the second barrier rib members are made of a non-transparent material.

8. A plasma display panel, comprising:
a first substrate and a second substrate that are substantially parallel and have a predetermined gap therebetween;
a plurality of address electrodes formed on a surface of the first substrate opposing the second substrate, the address electrodes being provided in a line pattern and substantially in parallel with each other;
a dielectric layer formed over a surface of the first substrate covering the address electrodes;
barrier ribs formed on the dielectric layer in a lattice pattern, the barrier ribs defining discharge cells;
a plurality of discharge sustain electrodes formed on a surface of the second substrate which opposes the first substrate, the discharge sustain electrodes being formed in a line pattern in a direction substantially perpendicular to the address electrodes; and
a transparent dielectric layer and a protection layer formed over the surface of the second substrate covering the discharge sustain electrodes,
wherein the barrier ribs include a plurality of first barrier rib members formed in a stripe pattern perpendicular to a direction of the address electrodes, and a plurality of second barrier rib members formed within a space between two neighboring first barrier rib members, the barrier rib members defining the discharge cells to be arranged in a zigzag manner along a same direction as the address electrodes, and
wherein at least one of the first barrier rib members and the second barrier rib members is made of a non-transparent material.

9. The plasma display panel of claim 8, wherein to establish the zigzag arrangement of the discharge cells, the discharge cells are arranged in the zigzag manner by arranging the second barrier rib members defining the discharge cells in a first space defined by a first pair of neighboring first rib members such that they are not aligned with the second barrier rib members defining the discharge cells located in a second space defined by a second pair of neighboring first rib members, wherein one rib member of the first pair of neighboring first rib members is also one of the first rib members in the second pair of neighboring first rib members.

10. The plasma display panel of claim 8, wherein to establish the zigzag arrangement of the discharge cells, a first set of the barrier rib members is formed on a first set of the address electrodes and a second set of the barrier rib members is formed on a second set of the address electrodes, wherein the second set of address electrodes includes at least one of the address address electrodes which is not part of the first set of address electrodes.

11. The plasma display panel of claim 8, wherein both of the first barrier rib members and the second barrier rib members is made of a non-transparent material.

12. The plasma display panel of claim 8, wherein a height of the first barrier rib members is greater than a height of the second barrier rib members, such that at least adjacent discharge cells may communicate via a space at an end of the second barrier rib members.

13. The plasma display panel of claim 8, wherein a height of the first barrier rib members is less than a height of the second barrier rib members, such that at least adjacent discharge cells may communicate via a space at an end of the first barrier rib members.

14. A method for manufacturing barrier ribs for a plasma display panel, comprising:
preparing a first substrate having address electrodes and a dielectric layer formed thereon, and printing a first insulating paste over a surface of the dielectric layer and forming a lower barrier rib member of a first predetermined height;
printing a second insulating paste on the lower barrier rib member in a line pattern, and forming upper barrier rib members having a second predetermined height from a surface of the dielectric layer;
coating a dry film resistor over a surface of the first substrate, fully covering the lower barrier rib member and the upper barrier rib members;
positioning a photo mask, which has a lattice-shaped light passage pattern, over an entire surface of the dry film resist, then performing exposure through the light passage pattern to pattern the dry film resist such that the dry film resist covers all of the upper barrier rib members and part of the lower barrier rib member; and
spraying sand at a high speed onto the surface of the first substrate such that exposed portions of the lower barrier rib member are removed, after which the dry film resist remaining on the first substrate is removed,
wherein either or both the first insulating layer paste and the second insulating layer paste are made of non-transparent material.

15. The method of claim 14, wherein the non-transparent material is a mixture of glass paste and a black pigment selected from the group consisting of chrome oxide, copper oxide, PbO, and Al₂O₃.

16. The method of claim 14, wherein both the first insulating layer paste and the second insulating layer paste are made of a non-transparent material.
